(19) United States
(12) Patent Application Publication
(10) Pub. No.: US 2009/0178531 A1
(43) Pub. Date: Jul. 16, 2009

(54) STATIONARY, MOTOR-DRIVEN UNDERFLOOR SAW

(76) Inventors: Rudolf Fuchs, Neuhausen (DE); Ulrich Mueller-Boysen, Esslingen (DE); Siegfried Keusch, Deizisau (DE); Markus Meier, Deizisau (DE); Sabine Rau, Denkendorf (DE)

Correspondence Address: MICHAEL J. STRIKER, 103 EAST NECK ROAD, HUNTINGTON, NY, 11743, US

(21) Appl. No.: 12/298,466

(22) PCT Filed: Oct. 30, 2007
(86) PCT No.: PCT/EP07/61681

§ 371 Date: Oct. 24, 2008

(30) Foreign Application Priority Data
Dec. 29, 2006 (DE) 10 2006 062 000.3

(51) Int. Cl. B27B 3/00

(52) U.S. Cl. 83/781

(57) ABSTRACT

The invention relates to a stationary, motor-driven underfloor saw (1), which is designed as a keyhole saw and can be displaced in the direction of the saw blade plane along the bench surface (13) as a trim saw. With respect to the position of the saw blade plane, said saw can be pivoted in relation to the bench (3) about an axis (50) that runs parallel to the intersection of the bench surface (13) and the saw blade plane.

The present invention relates to a stationary, motor-driven underfloor saw according to the preamble of claim 1.

### BACKGROUND INFORMATION

Underfloor saws designed as table-top circular saws are known from practical use, with which the motor and the saw blade—which is connected coaxially therewith—are connected to form a saw unit, the saw blade of which extends above the bench—which is mounted on a base—with its particular upper segment. The cutting direction is defined for a particular sawing procedure via the saw blade plane. The cutting height, which is determined by the height of the saw blade above the plane of the bench, and the cutting angle, which is determined by the angular displacement of the saw blade plane relative to the bench surface, are also adjustable. The adjustable cutting angle is limited by the coaxial extension of the motor toward the axis of the saw blade, due to the dimensions of the motor and depending on the distance between the motor axis and the bench. The applications of table-top circular saws of this type are therefore limited. In particular, it is not possible to saw around curves.

Additional possibilities in this regard are realized with table-top saws designed as bandsaws.

Furthermore, motor-driven, hand-held reciprocating saws—which are known as jigsaws—are known from practical application. Similar to bandsaws, these saws include a saw blade, which is narrow in the direction of the saw blade plane and which may therefore be used to saw around curves.

### DISCLOSURE OF THE INVENTION

The object of the present invention is to create an underfloor saw with particularly variable applications, which also delivers high-quality working results with a high level of user-friendliness and a relatively simple design.

This is attained with the means of attaining this object according to the present invention by the fact that the underfloor saw is designed as a reciprocating saw, and possibly as a pendulum-reciprocating saw, which simplifies handling and provides diverse possibilities for adjustment, while also improving overall work safety and providing good options for adjustment.

When the saw unit extends in the direction of the saw blade plane, the saw blade may be swiveled toward either side, transversely to the saw blade plane, without being hindered by the drive unit of the saw unit. Via this assignment and an appropriate design of the drive unit—which includes the motor and the drive part, which is located in the connection of the motor with the saw blade—a relatively flat design of the base on which the bench is mounted may be realized, which includes large possible swivel angles.

This is realized even in combination with a relatively short bench length in the cutting direction, even when the saw unit—in the sense of the embodiment of the underfloor saw—is movable as a slide saw along the bench surface in the direction of the saw blade plane.

Regardless of the design as a slide saw, which makes it possible to perform work in a largely risk-free manner even with small work pieces, and regardless of the changeability of the cutting angle of the saw blade relative to the bench surface, high cutting accuracies may be attained when the saw unit is swivelable—relative to the bench—about an axis that is parallel to the line of intersection of the bench surface and the saw blade plane, and that is adjacent to the bench surface. Particularly high cutting accuracies result when the swiveling axis also lies in a plane with an edge of the saw blade, or in a plane that intersects the cross section of the saw blade, so that the swiveling axis for the procedure of sawing a work piece lying on the bench forms a reference line that is unaffected by the angular changes.

In the embodiment of the underfloor saw as a reciprocating saw, the saw unit is preferably supported by the bench such that it is longitudinally displaceable relative to the bench. The saw unit and bench are therefore a single assembly unit, it being possible, expediently, to lock the saw unit in its longitudinal position along the slide path, and to limit the slide path depending on the particular requirements, in particular by using stops.

In a refinement of the present invention, the bench is preferably mounted on the base in a vibration-decoupled manner, so that the relatively heavy bench acts as a damping mass relative to the vibrations that occur, and so that the vibrations do not have an exciting effect on the base, thereby preventing the development of noise—which would be amplified by resonance—which would impair working comfort and limit the possible applications.

Based mainly on the refinement of the underfloor saw as a slide saw, it is expedient when the saw unit is connected with the bench via a support carriage, and is supported against the support carriage on a guide path that determines its swiveling axis, because the various adjustment possibilities may be expediently combined in this manner.

For example, preferably, the saw unit may be connected with a toothed ring segment that is concentric with the guide path of the support carriage, the toothed ring segment meshing with an actuator wheel—which is supported on the carriage side—of an angular adjustment device, thereby enabling the angular adjustment device to be adjusted—regardless of the particular angular position or the particular displacement position of the support carriage along the guide path—using a handle, which is located on the end face and is assigned to the base, the handle being connected with the actuator wheel in a torque-transferring manner. This may be easily attained using an eccentric shaft that connects the handle with the actuator wheel, along which the actuator wheel—which is assigned to the support carriage—is displaceable, it also being preferably possible to lock the adjusted swiveling position and actuator positions in place.

The toothed ring segment is preferably acted upon by two actuator wheels, which are offset in the circumferential direction, thereby making it possible to attain large angular displacements to either side given a short arc length of the toothed ring segment. For this purpose, a belt drive that connects the rotatable handle with the eccentric shafts, in particular a toothed belt drive that works in a form-fit manner, is preferably provided, which connects a gearwheel driven by the handle with guide wheels mounted on the eccentric shafts. This transmission connection is preferably located in the region of the end face of the base of the underfloor saw, to which the devices to be adjusted by the operator and/or to be observed are assigned.

With regard for working in a precise manner with the underfloor saw according to the present invention, its bench is provided with guide grooves, which extend in parallel with the cutting plane, i.e., in the longitudinal direction, which preferably extend across the length of the bench, and in which a stop guide may be moved in a longitudinally-displaceable manner. It is also advantageous when the bench is provided with a connection profile on its longitudinal and/or transverse edges, via which, e.g., longitudinal or transverse extensions of the bench may be attached. The connection profiles are also preferably designed as dovetail-type—preferably prism-shaped—profiles, and the connection profiles on the longitudinal sides are preferably assigned to the lateral edge surface of the bench and are preferably open toward the side, thereby making it possible to easily insert the lateral bench extensions in the longitudinal direction when good support is provided.

The connection profiles assigned to the transverse edges, which are also preferably designed as dovetail profiles, are open toward the bench surface and preferably have a shape that also allows the support carriage to be displaced in the region of these longitudinal extensions. As a result, the bench length is increased, and the displacement path for the saw unit is extended. The longitudinal and transverse extensions may be fixed in position relative to the bench, which is connected with the base, using lock-in connections or the like.

With regard for the positioning of the saw blade such that it may pass through the bench, with the base of the saw unit being located underneath the bench, the bench is subdivided longitudinally along the displacement range of the saw unit. Expediently, the bench includes longitudinal grooves, which extend in the longitudinal direction, e.g., to prevent the particular work piece from becoming stuck on the bench.

Further advantages and expedient embodiments are depicted in the claims, the description of the figures, and the drawing.

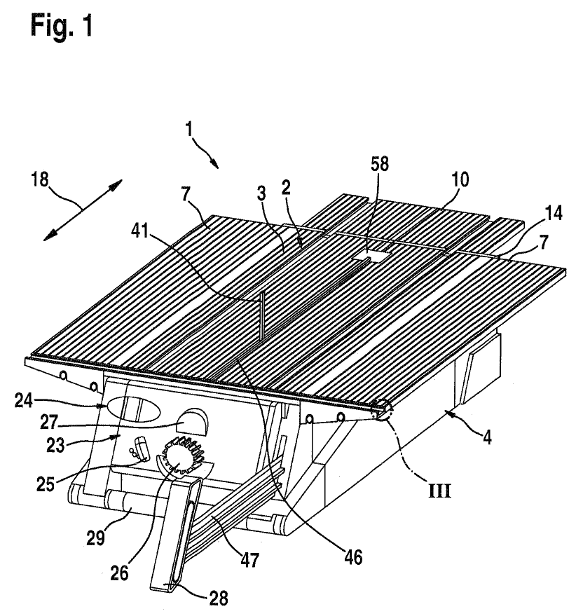

FIG. 1 is a perspective depiction of a stationary, motor-driven underfloor saw according to the present invention, in a front view at an angle from above,

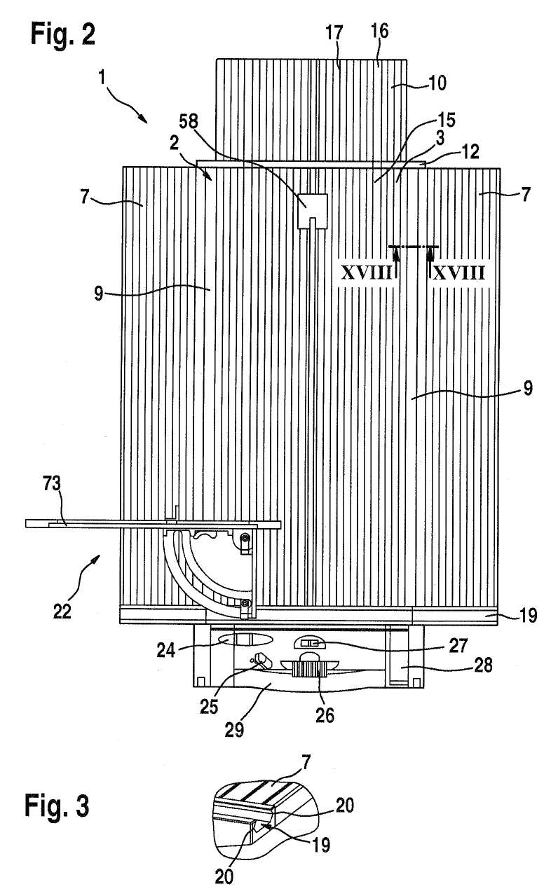

FIG. 2 is a top view of the depiction shown in FIG. 1, plus a stop device, which may be used as a parallel, angular, or transverse stop, and which is guided in a longitudinally displaceable manner in guide grooves in the bench, which are recessed in the bench surface,

FIG. 3 shows an enlarged section III of FIG. 1, which shows the cross-sectional shape of connection profiles provided in the transverse edges of the bench,

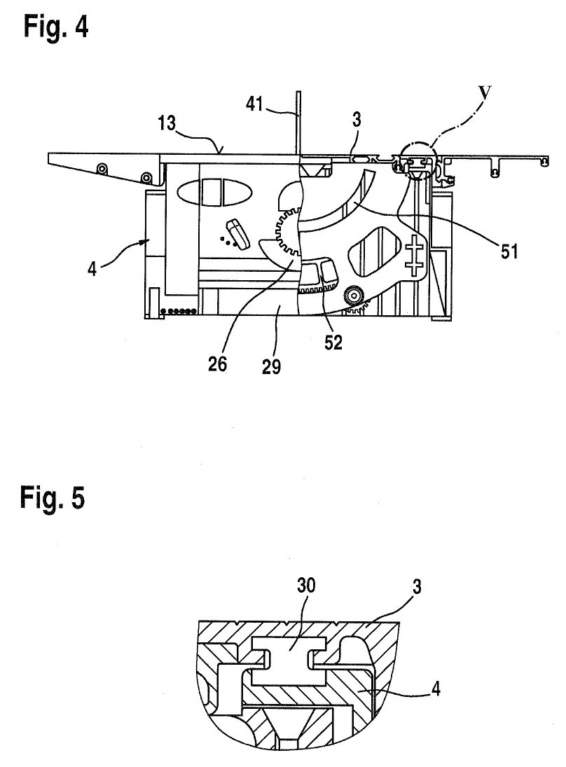

FIG. 4 is a front-end view of the saw table with base, as a cross-sectional view of half of one side,

FIG. 5 is an enlarged view of section V in FIG. 4, which shows the vibration-decoupled connection of the bench of the saw table with the base,

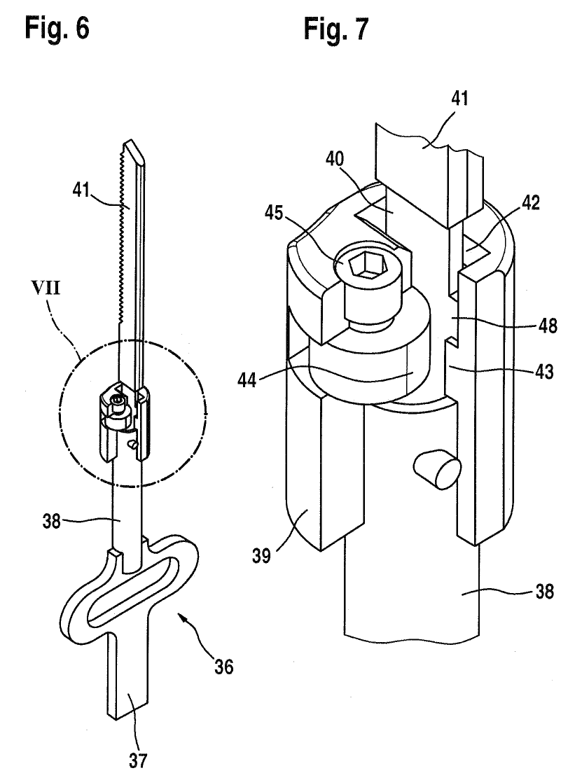

FIGS. 6 and 7 show the saw blade receptacle of the saw, which is designed as a reciprocating saw/jigsaw, in a perspective view, and in an enlarged view of section VII in FIG. 6,

FIG. 8 shows a section provided in the bench, which overlaps in order to receive the saw blade, with an assigned cover, with the cover swiveled upward, in a top view,

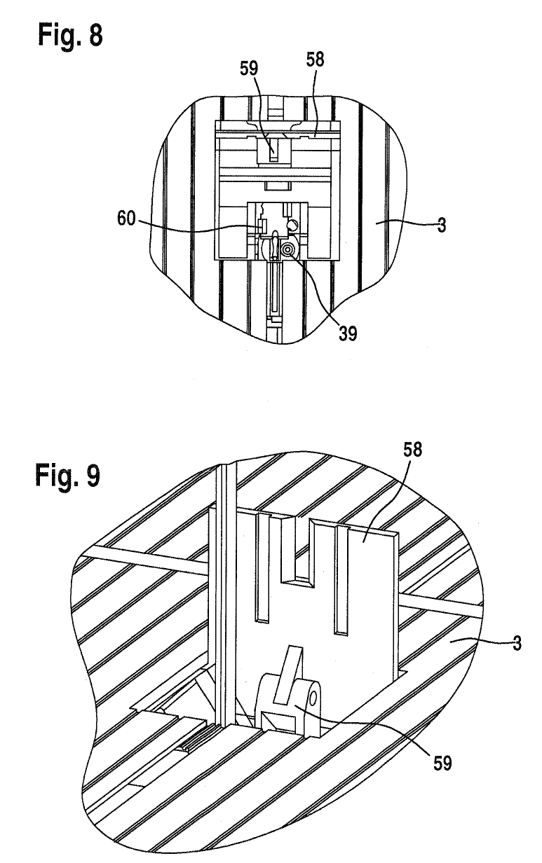

FIG. 9 shows a perspective depiction of the cover design in FIG. 8, with the cover in place,

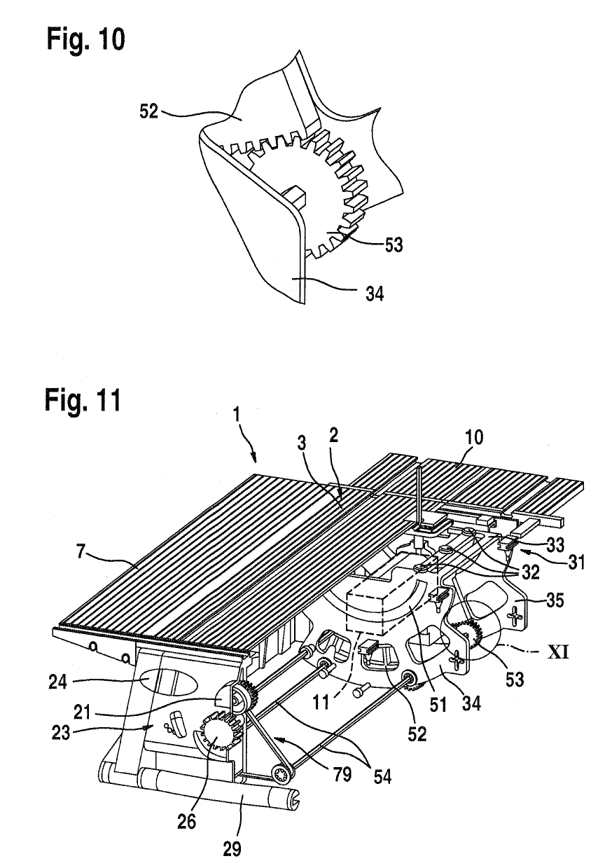

FIG. 10 shows a partial cross-section through the underfloor saw in FIG. 4, in a perspective view at an angle from above,

FIG. 11 shows an enlarged view of section XI in FIG. 10,

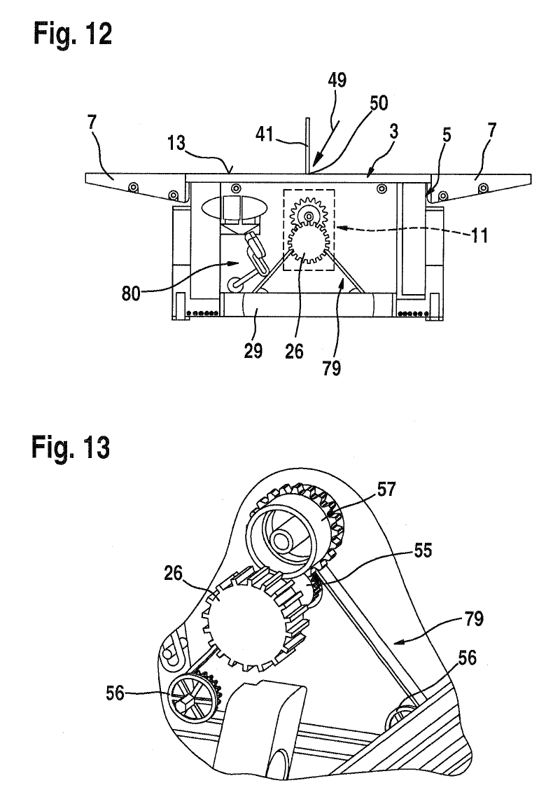

FIG. 12 is a schematic, front-end view of the handle—which is designed as a rotary knob—of an angular adjustment device, via which the saw unit—which is mounted on a support carriage—and the saw blade assigned thereto may be adjusted with regard for their angular position relative to the bench, the drive connection being depicted only schematically,

FIG. 13 shows a perspective, detained depiction of a drive connection per FIG. 12, which is designed as a belt drive,

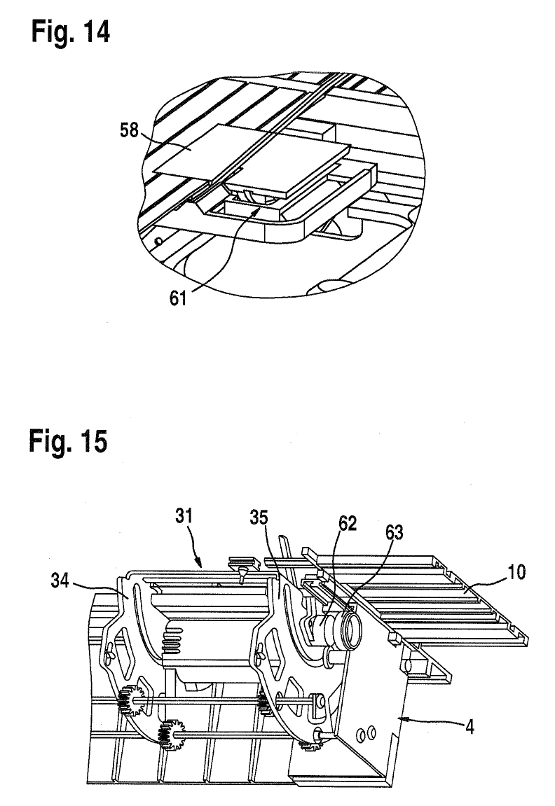

FIG. 14 shows a dust-collection shell, which is located in the region of the section covered by the cover, is located underneath the cut-out section for the bench, and is connected with the support carriage for the saw unit,

FIG. 15 shows a depiction of a part of the illustration shown in FIG. 10 in a further perspective, the connection for dust extraction being shown,

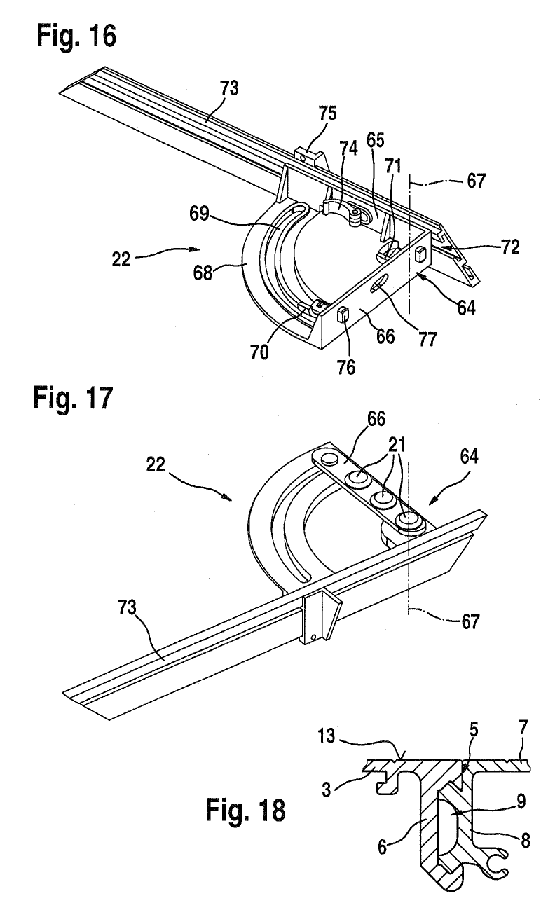

FIGS. 16 and 17 show perspective depictions of the stop device in a mirror view from the top and bottom, and

FIG. 18 shows a sectional view along the line XVIII-XVIII in FIG. 2 of the connection profile—which is assigned to the bench on the longitudinal-edge side—for a side extension for a bench, or any other type of devices and/or assemblies to be attached to the bench on the longitudinal-edge side.

Underfloor saw 1 shown in the figures includes a saw table 2 with a base 4 and a bench 3, which covers base 4. In the illustrations, longitudinal bench side-extensions 7 and an end-face panel extension 10 are assigned to bench 3. Bench 3, bench side-extensions 7, and bench extension 10 form a single bench surface 13 (FIG. 4), and grooves 17, which extend longitudinally along bench surface 13 are provided, the longitudinal extension of saw table 2 being indicated via arrow 18.

Bench side-extensions 7 and bench extensions 10 are connected via connection profiles, which are assigned to the longitudinal sides and/or a transverse side of bench 3. FIG. 18 shows connection profile 6, which is assigned to a longitudinal side 5 of bench 3. Bench side-extension 7 has a counter-profile 8. Connection profile 6 and counter-profile 8 join to form a connection profile 9 with a dovetail shape and, in particular, which has a prismatic cross section. A related connection profile 12 is also assigned to transverse side 14, which is located in the transition of bench 3 to bench extension 10, which is not shown in detail.

Guide grooves 15, 16 are also provided in the longitudinal direction (arrow 18) of bench 3 and, adjacent thereto, in bench extension 10. A related, continuous guide groove 19 is also provided on end of bench 3 opposite to bench extension 10, and on bench side-extension 7. Guide grooves 15, 16, and 19 are designed open toward bench surface 13, i.e., toward the top, each being designed as an undercut U-profile, whose opposing edges 20 are notched or arched outwardly in a rooflike manner, i.e., they are prismatic in shape, thereby resulting in an exact guidance for guide rollers 21, as provided, e.g., on a displaceable stop device 22, the angular position of which is adjustable in the longitudinal direction (arrow 18), and which is shown in greater detail in FIGS. 16 and 17.

Base 4, which is designed in the manner of a housing, includes a number of operating elements on its end face 23, which is designed as the control side, operating elements being labeled with reference numerals 24 through 28, and whose functions will be described in greater detail below. Base 4 is also provided with a carrying handle 29 in the region of end face 23.

As shown in FIGS. 4 and 5, bench 3 of saw table 2 is supported relative to the base in a floating manner via elastomeric buffers 30. Several elastomeric buffers 30 of this type are preferably provided, at a distance from one another. In addition, in particular, appropriate elastic supports are provided along the end faces that extend in the transverse direction. As a result, despite the floating—i.e., separated—support of bench 3 relative to base 4, a position for bench 3 is attained that is adequately stable. Guides that extend in longitudinal direction 18 are provided on the underside of bench 3, although this is not depicted in detail. A support carriage 31 is supported in the guides in a displaceable manner via guide rollers 32.

As shown in FIG. 10 and, to a partial extent, in FIG. 15, support carriage 31 has a bridge-type design, and guide rollers 32—which preferably have a prismatic cross-section—are located along segment 33, which connects cheeks 34, 35, which extend transversely to longitudinal direction 18.

The saw unit is located between cheeks 34, 35. Drive unit 11 of the saw unit, which includes the motor, is indicated as a dashed line, and it is connected on the output side via its reciprocating mechanism—as also shown in FIGS. 6 and 7—with a saw-blade receptacle 36, the drive shank 37 of which guides a tool shank 38. Tool shank 38 carries a clamping-body housing 39, which is shown in an enlarged view in FIG. 7, and which accommodates fastening part 40 of saw blade 41. For this purpose, fastening part 40 is inserted into slot 42 of clamping-body housing 39, and comes to bear—with lateral deformations 48—against an inner collar 43 of clamping housing 39. In this position, fixation takes place via a preferably spiral-shaped clamping eccentric 44, which is supported axially in clamping-body housing 39, and which is to be locked in its clamping position, which holds saw blade 41 in place, via a clamping screw 45 with a hexagonal head.

Saw blade 41 passes through bench 3, in saw slot 46, which extends along the length of bench 3 to cover 58. Saw blade 41 determines the sawing plane, which extends in longitudinal direction 18 of saw table 2, and the drive part—with saw blade receptacle 36, which is movable in a reciprocating manner in accordance with the sawing function—essentially lies in the direction of the extension of the saw blade plane, shifted downward relative to the bench plane, in the resion of support carriage 31.

Support carriage 31 in shown in an end position in FIGS. 10 and 11, starting at which the saw unit—which includes saw blade 41, the motor, and the associated drive parts of drive unit 11—is movable in longitudinal direction 18 against control-side end face 23, and, in fact, along a slide rail 47, which engages with support carriage 31 and is guided via support carriage 31, slide rail 47 ending on the control side in a slide handle 38 as a control element.

The cutting angle, i.e., the angular position relative to bench surface 13, of saw blade 41 is adjustable. For this purpose, the saw unit is swivelably supported in support carriage 31, thereby forming a swiveling axis 50, which is determined by the line of intersection between bench surface 13 and the plane of saw blade 41. Swiveling axis 50 is preferably defined such that it—as indicated in FIG. 12 with arrow 49—coincides with an edge of saw blade 41, and possibly also extends in a plane that intersects the cross section of saw blade 41. To realize a swiveling axis of this type, the saw unit is movable along a guide track 51 in cheeks 34, 35, the center point of which is determined via swiveling axis 50. At least one toothed ring segment 52, which is concentric with guide track 51 and is located opposite to the saw unit is assigned to at least one of the cheeks 34, 35, toothed ring segment 52 extending with its toothed region along an arc, which engages in all realizable angular positions with at least one actuator wheel 53 with a rotation axis that is fixed relative to particular cheek 34 or 35. In the exemplary embodiment, actuator wheels 53, which are separated from each other, are provided in the circumferential direction of toothed ring segment 52 and, in a related manner, in the circumferential direction of guide track 51. Toothed ring segment 52 has an arc length, via which at least one actuator wheel 52 meshes with toothed ring segment 52, thereby making it possible to design toothed segment 52 to be relatively short. In the exemplary embodiment, cutting angles of up to 45° are possible by swiveling the saw unit with drive unit 11, which is narrow in the transverse direction, and which extends essentially in the direction of the saw blade plane along bench 3, and/or which extends downwardly, thereby making it possible to realize large swivel angles toward either side. With regard for the longitudinal displaceability of support carriage 31 axially toward particular cheek 34 or 35, actuator wheels 53 are fixed in position and are non-rotatably connected with an eccentric shaft 54, which extends in longitudinal direction 13 and makes it possible—when fixed in position axially relative to base 4—to adjust the angular position of saw blade 41 regardless of the particular longitudinal position of support carriage 31 using one of the control elements, i.e., using the handle designed as rotary knob 26, which is situated coaxially with a gearwheel 55, which is connected with shafts 54 via a slip-free drive connection 79. As shown in FIG. 13 in particular, slip-free drive connection 79 is designed as a belt connection that operates in a form-fit manner, in particular as a toothed belt configuration, the belt of which is guided—in a manner that corresponds to gearwheel 55—via guide wheels 56, which are non-rotatably mounted on eccentric shafts 54. A belt-clamping device is labeled with reference numeral 80.

In addition, as shown in FIG. 13, an angular scale 57 is rotatably connected with the rotary knob, which is used as handle 26, and/or with gearwheel 55. Angular scale 57 may be read through a viewing window 27 provided in the control panel. For this purpose, viewing window 27 overlaps angular scale 57 in the axial direction.

An on/off switch 24 is also provided on the control panel, as is a controlling device 25, which, when the saw unit is designed as a reciprocating saw and, specifically, as a pendulum reciprocating saw, is used to adjust the oscillating motion.

A cover 58, which forms a portion of bench surface 13, is provided in bench 3 such that it overlaps drive unit 11 of the saw unit, in the end position shown in FIG. 1, in the region of penetration of saw blade 41. Cover 58 covers a cut-out section of bench 3 and enables access to clamping-body housing 39, opposite to which saw blade 41 is fixed in position via clamping eccentric 44. To replace a saw blade 41 with a different, appropriate tool, it is only necessary to open cover 58. Clamping screw 45 is located such that it may be accessed directly via cut-out section in bench 3 when the cover is removed. FIG. 9 shows the opened position of cover 58, which is fixed in position relative to bench 3 via a hinge 59, the axis of hinge 59 being located underneath bench surface 13. Similar to gas-tank covers on motor vehicles, hinge 59 is located off-center in the region of the end of cover 58, relative to the longitudinal extension of closed cover 58. End of cover 58 dips below the plane of the bench when cover 58 is opened.

The access situation for clamping-body housing 39 and clamping screw 45 when cover 58 is opened is also illustrated in FIG. 8, where it is also shown that a sliding guide may be provided, e.g., via ceramic elements 60 located on one or both sides, to guide saw blade 41 transversely within its oscillating range. Ceramic elements 60 may be easily replaced when cover 58 is opened. Cover 58 may therefore be regarded as a maintenance flap, practically speaking.

FIG. 14 also shows—in combination with FIG. 15—that a dust-collection shell 61 may be provided in the region of cover 58, in order to cover drive parts of the saw unit located beneath it, dust-collection shell 61 being connected with a dust-extraction connection 62, which is assigned to a cheek 35 of support carriage 31 not located on the control side, and which is connected via a connection tube with a sliding cuff 63, which is located opposite to base 4 and is assigned to the control side, thereby making it possible to work with the underfloor saw according to the present invention in a manner that produces practically no dust in the surroundings either.

An embodiment of stop device 22, which is expedient according to the present invention, which is displaceably supported via guide rollers 21 in a guide groove 15, 16—which extends in the longitudinal direction—of bench 3, and is possibly also supported in transversely extending guide groove 19, is shown in FIGS. 16 and 17.

Stop device 22 includes an angular stop carrier 64, whose legs 65, 66 are swivelable relative to one another about an axis 67, which is perpendicular to bench surface 17. Legs 65, 66 are connected in the region of their free ends via a flat annular section 68, which includes a guide slot 69 that is concentric with axis 67, and through which a clamping device 70 passes, which connects annular section 68 with leg 66 on which guide rollers 21 are provided. Clamping device 70 is preferably designed as an eccentric clamping device. A clamping device 71 is also provided, via which leg 66 on which guide rollers 21 are mounted is clampable against bench 3 in the region of guide groove 15 and 16, which accommodates guide rollers 21.

In the exemplary embodiment, a stop rail 73 is attached to leg 65 in a longitudinally displaceable manner via a sliding guide 72, and, in fact, it may be locked in its particular longitudinal position relative to leg 65 via a clamping device 74. Clamping device 74 is preferably designed as an eccentric clamping device, which clamps stop rail 73 against leg 65 in the region of sliding guide 72. A rider 75 is displaceably guided on stop rail 73.

Legs 65, 66 are preferably designed such that stop rail 73 may be installed on either leg 65, 66. As shown in FIG. 16, the legs—as shown for leg 66—are provided with peg-like projections 76, which engage in the sliding guide, between which opening 77 for clamping device 74 is located.

What is claimed is:

1. A stationary, motor-driven underfloor saw (1), comprising a saw table (2), which includes a bench (3)—with a bench surface (13)—supported over a base (4), comprising a saw blade (41), which passes through the bench surface (13) and extends upwardly above the bench surface (13), and comprising a drive unit (11), which includes a motor and is connected with the saw blade (41) to form a saw unit,
wherein
the underfloor saw (1) is designed as a reciprocating saw.

2. The underfloor saw as recited in claim 1,
wherein
the saw unit extends in the direction of the saw blade plane.

3. The underfloor saw as recited in claim 1,
wherein
the saw unit is swivelable relative to the bench (3), about a swiveling axis (50), which extends in parallel with the line of intersection of the bench surface (13) and the saw blade plane, and which is adjacent to the bench surface (50).

4. The underfloor saw as recited in claim 3,
wherein
the swiveling axis (50) extends in a plane that intersects the cross section of the saw blade (41).

5. The underfloor saw as recited in claim 3,
wherein
the swiveling axis (50) lies in a plane with one of the edges of the saw blade (41).

6. The underfloor saw as recited in claim 1,
wherein
the saw unit may be moved in the direction of the saw blade plane, along the bench surface (13).

7. The underfloor saw as recited in claim 6,
wherein
the saw unit may be locked in position in at least one displacement position.

8. The underfloor saw as recited in claim 6,
wherein
the underfloor saw is designed as a slide saw.

9. The underfloor saw as recited in claim 8,
wherein
the sliding length of the slide saw is adjustable using stops.

10. The underfloor saw as recited in claim 1,
wherein
the saw unit is supported such that it is displaceable in the longitudinal direction via the bench surface (3).

11. The underfloor saw as recited in claim 1,
wherein
the bench surface (3) is attached to the base (4) in a vibration-decoupled manner.

12. The underfloor saw as recited in claim 1,
wherein
the saw unit is connected with the bench (3) via a support carriage (31), and it is supported against the support carriage (31) on a guide path (51) that determines its swiveling axis (50).

13. The underfloor saw as recited in claim 12,
wherein
the saw unit includes a toothed ring segment (52), which is concentric with the guide path (51) of the support carriage (31), and which meshes with an actuator wheel (53)—which is supported on the carriage side—of an angular adjustment device.

14. The underfloor saw as recited in claim 13,
wherein
the angular adjustment device includes a handle (26), which is assigned to the base (4) and is located on the end face, and which is connected with the actuator wheel (53) in a torque-transferring manner.

15. The underfloor saw as recited in claim 14,
wherein
the connection of the handle (26) with the actuator wheel (53) includes an eccentric shaft (54), along which the actuator wheel (53) is displaceable.

16. The underfloor saw as recited in claim 13,
wherein
the toothed ring segment (52) is acted upon by two actuator wheels (53), which are offset in the circumferential direction, and the eccentric shafts (54) assigned thereto are connected with the rotatable handle (26) in a driving, slip-free manner.

17. The underfloor saw as recited in claim 16,
wherein
the slip-free, driving connection (79) is designed as a belt drive.

18. The underfloor saw as recited in claim 1,
wherein
the bench (3) in the bench surface (13) is provided with guide grooves (15, 16, 19), which extend in the longitudinal and/or transverse direction.

19. The underfloor saw as recited in claim 1,
wherein
the bench (3) is provided with a connection profile (9, 12) on its longitudinal and/or transverse sides.
